(19) United States
(12) Patent Application Publication
(10) Pub. No.: US 2007/0295767 A1
(43) Pub. Date: Dec. 27, 2007

(54) Package for pouring a product

(76) Inventors: Antonio Victor Angelo, Norwood, OH (US); Dennis J. Ruehl, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/473,787

(22) Filed: Jun. 23, 2006

(51) Int. Cl. B67D 3/00

(52) U.S. Cl. 222/564

(57) ABSTRACT

A package for dispensing a pourable product has a first hollow body member, a second hollow body member, and a pouring spout. The first hollow body member has a first exterior surface and opposite therefrom a first interior surface which defines a first internal volume. The second hollow body member has a second exterior surface, a second interior surface, a flow-regulating passage, and a dispensing passage separate from the flow-regulating passage. The second exterior surface defines a second external volume smaller than the first internal volume. Opposite the second exterior surface, the second hollow interior surface defines a second internal volume. A fastener is formed on the second interior surface. The pouring spout is operatively connected to the dispensing passage.

### CROSS REFERENCE OF RELATED APPLICATIONS

This application claims the benefit of U.S. application Ser. No. 11/196,969, filed on Aug. 4, 2005, which claims the benefit of U.S. Provisional Application No. 60/600,970, filed on Aug. 12, 2004.

### FIELD OF THE INVENTION

The present invention relates to a package for a granular or a fluid product. Specifically, the present invention relates to a transition which can be used to pour granular or fluid products.

### BACKGROUND OF THE INVENTION

Containers having transitions are well known in the art. Such containers have been used for a multitude of products including chemical packages, food packages, cleaning packages, and the like. The transitions are typically attached to the container for the purpose of directing any materials contained within the container out in a controlled manner. They also facilitate various means of closing a package, such as providing an area to which a lid or cap can be attached. The transitions associated with containers often have additional benefits relating to such areas as self-draining and flow-limiting capabilities.

Because a fluid product has different flowability characteristics than a granular product, a different transition is used for the fluid product than the granular product to provide ease of dispensability that can permit accurate, controlled dosing. For example, fluid products provide more of a steady rate of pouring or discharge whereas solid products do not provide the steady rate of pouring or discharge of product in a narrow bulk flow stream, especially when the width of the stream is narrow compared to a product's particle size. Thus, substantially different transitions are needed because of the different flowability characteristics of granular products versus fluid products.

However, in terms of materials and manufacturing, it is not sufficiently cost effective for use in mass production of transitions to have two separate transitions. In contrast, the cost of a typical product package must be kept to a minimum because, among other reasons, it is generally disposed of after substantially all of a product stored within has been dispensed. Thus, one transition which can be used for both fluid and granular products is desirable. Such a transition would be even more desirable if it can create a desirable consumer experience for a consumer using a fluid product as well as a consumer using a granular product. The present invention addresses these problems.

Accordingly, there is a need for a cost effective, mass produceable transition which can be used for both granular and fluid products. Moreover, the need exists for one transition which can be used for dispensing a granular product as well as a fluid product, which accurately pours to a desired location, and which is easy and convenient to use.

### SUMMARY OF THE INVENTION

The present invention relates to a package for dispensing a pourable product having a first hollow body member, a second hollow body member, and a pouring spout. The first hollow body member has a first exterior surface and opposite therefrom a first interior surface which defines a first internal volume. The second hollow body member has a second exterior surface, a second interior surface, a flow-regulating passage, and a dispensing passage separate from the flow-regulating passage. The second exterior surface defines a second external volume smaller than the first internal volume. Opposite the second exterior surface, the second hollow interior surface defines a second internal volume. A fastener is formed on the second interior surface. The pouring spout is operatively connected to the dispensing passage.

When the first internal volume is at least about 50% full of the pourable product, the package may be tilted for dispensing at a dispensing angle which causes the pourable product to flow from the first internal volume through the flow-regulating passage into the second internal volume and from the second internal volume through the dispensing passage out of the package. When the flow rate is measured and calculated at a dispensing angle of 120°, the standard deviation is less than about 20 grams of the average flow rate. When the flow rate is measured and calculated at a dispensing angle of 150°, the standard deviation is less than about 20 grams of the average flow rate.

### BRIEF DESCRIPTION OF THE DRAWINGS

While the specification concludes with claims particularly pointing out and distinctly claiming the invention, it is believed that the invention will be better understood from the following description of the accompanying figures in which like reference numerals identify like elements, and wherein:

FIG. 1a is a cut-away side view of an embodiment of the package of the present invention;

FIG. 1b is perspective view of an embodiment of a second hollow body member;

FIG. 2 is a cut-away side view of an embodiment of the package of the present invention during dispensing;

FIG. 3 is a partial cut-away side view of a comparative package; and

FIG. 4 is a close-up side view of an embodiment of the second hollow body member.

FIG. 5 is a side view of an alternative embodiment of the package of the present invention.

The figures herein are not necessarily drawn to scale.

### DETAILED DESCRIPTION OF THE INVENTION

Section A will provide terms which will assist the reader in best understanding the features of the invention, but not to introduce limitations in the terms inconsistent with the context in which they are used in this specification. These definitions are not intended to be limiting. Section B will discuss the package of the present invention. Section C will discuss the Flow Rate Test Method. Section D will discuss examples of the present invention.

### A. TERMS

All temperatures herein are in degrees Celsius (° C.) unless otherwise indicated. As used herein, the term “comprising” means that other steps, ingredients, elements, etc. which do not adversely affect the end result can be added. This term encompasses the terms “consisting of” and “consisting essentially of”.

As used herein, the term “granules” and variants thereof mean any non-fluid composition.

As used herein, the term “fluids” and variants thereof mean any composition capable of wetting. The composition can include solids or gases in suitably subdivided form, but the overall composition excludes product forms which are substantially nonfluid overall, such as tablets or granules.

By the term “pourable product,” it is meant herein a pourable product which can be either a granule or a fluid. For example, the granules can be a granular food, a granular detergent, chemicals, etc. In another embodiment of the invention herein, the product can be a granular product selected from the group consisting of salt, flour, baking soda, baking powder, sugar, and a mixture thereof. In an embodiment of the invention herein, the product can be a granular detergent selected from the group consisting of a laundry detergent composition, an autodishwash composition, a disinfecting composition, a cleaning composition, a personal cleansing composition, and a mixture thereof. The granular product should be a free-flowing granular product. In an embodiment herein, the granular product has an approximately regular shape, preferably a regular shape, such as a sphere, a crystal, a cube, etc. Without intending to be limited by theory, it is believed that typically, the more regular the shape of the particles in the granular product, the better the free-flowing properties of the granular product. In another embodiment herein, the granular product has an average particle diameter, which is the number average particle diameter which can be calculated by methods known in the art, and where the particle diameter is defined as the straight distance between the two farthest points on an individual particle. In an embodiment herein, the granular product has an average particle size and a standard deviation of less than about 30% of the average flow rate, or from about 0% to about 30% of the average flow rate. The pourable product can also be fluid.

### B. PACKAGE OF THE PRESENT INVENTION

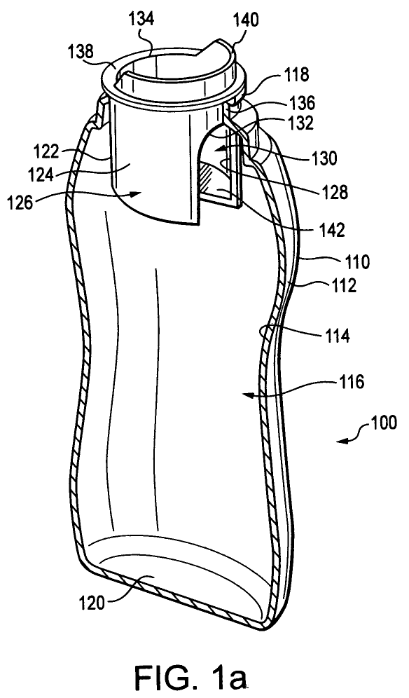

Turning to FIG. 1a which shows a cut-away side view of a package, 100, having a first hollow body member, 110, having a first exterior surface, 112, and a first interior surface, 114, opposite the first exterior surface, 112. The first interior surface, 114, defines a first internal volume, 116, which is further bounded by the mouth, 118, which is formed where the first exterior surface, 112, meets the first interior surface, 114. Thus, in this embodiment, the first internal volume, 116, ends at the plane formed by the mouth, 118. Opposite the mouth, 118, is a package bottom, 120, which in FIG. 1a is flat so as to allow the package, 100, to stably rest.

FIG. 1a also shows a second hollow body member, 122, which in this embodiment is distinct from the first hollow body member, 110. The second hollow body member, 122, has a second exterior surface, 124, which defines a second external volume, 126, which is smaller than the first internal volume, 116. In an embodiment herein, the second external volume, 126, can be less than about 50% of the first internal volume, 116. The second hollow body member, 122, also has a second interior surface, 128, opposite the second exterior surface, 124. The second interior surface, 128, defines a second internal volume, 130. In an embodiment herein, the second internal volume, 130, can be from about 1% to about 25% of the first internal volume, 116. In another embodiment herein, the second internal volume, 130 can be from about 2% to about 15% of the first internal volume, 116.

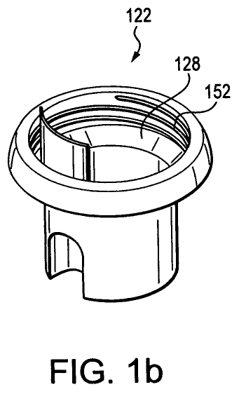

Referring FIG. 1b, disposed on the second inferior surface, 128, of the second hollow body member, 122, are fasteners, 152, (e.g. threads), which cooperate with fasteners, 154, (e.g. threads) (shown in FIG. 2) on cap, 146, (shown in FIG. 2) when the cap, 146, (shown in FIG. 2) is fixed to the second hollow body member, 122. The fastener can be of any suitable object which joins the second hollow body member, 122, to the cap, 146 (shown in FIG. 2). The fastener can be including, but not limited to, lugs, grooves, threads, or plug seals.

Referring to FIG. 1a, the second hollow body member, 122, contains a flow-regulating passage, 132, which leads from the second exterior surface, 124 to the second interior surface, 128. Distal and separate from the flow-regulating passage, 132, is a dispensing passage, 134, that leads from the second interior surface, 128, to the second exterior surface, 124.

In FIG. 1a, generally the second hollow body member, 122, can be fixedly joined to the first hollow body member, 110, in any way known in the art. The second hollow body member, 122, can also be monolithic with the first hollow body member, 110, for example, by molding the first hollow body member, 110, and the second hollow body member, 122, as one piece. In one non-limiting example, the second hollow body member, 122, can be fixedly joined to the first hollow body member, 110, by friction fitting that snaps parts together, gluing, and/or melting. In another non-limiting example, the second hollow body member, 122, can also be a continuation of the first hollow body member, 110, by folding or compressing a portion of the first hollow body member, 110, and turning the first hollow body member, 110, inwards upon itself to create the second hollow body member, 122.

In FIG. 1a, the second exterior surface, 124, can be affixed to the mouth, 118, via an adhesive, 136. However, the second exterior surface may also be affixed to the mouth, 118, by, for example, a pressure seal, an adhesive seal, a locking closure, a screw-type closure, a snap-fit closure, a heat seal, an ultrasonic seal, and/or a plug-seal and may optionally be air-tight and/or water-tight as desired for example, to prevent oxidation of the pourable product, absorption of moisture from the air, and/or water damage to the pourable product. In an embodiment herein, the second exterior surface, 124, is removably affixed to the mouth, 118. Also in FIG. 1a, the dispensing passage, 132, is bounded by an edge, 138, at the second exterior surface, 124. The edge, 138, is affixed to the mouth, 118, so that a majority of the second hollow body member, 122, is contained within the first internal volume, 116, but this not need be the case. In the present invention, the second hollow body member, 122, need only be at least partially within the first internal volume, 116.

In FIG. 1a, connected to the dispensing passage, 134, is a pouring spout, 140, which helps direct the pourable product, 144, (see FIG. 2) when the package, 100, is tilted for dispensing (see FIG. 2.). The pouring spout, 140, can have a height of from about 0 mm to about 110 mm. The second hollow body member, 122, has a base, 142, opposite the dispensing passage, 134. The flow-regulating passage, 132, extends from near the mouth, 118, to the base, 142. In addition, the base, 142, is slanted towards the flow-regulating passage, 132, so that when the package, 100, is placed flat on the package bottom, 120, on a flat surface, any pourable product, 144, (see FIG. 2) which remains in the second internal volume, 130, will flow back through the flow-regulating passage, 132, and into the first internal volume, 116.

FIG. 2, shows a cut-away side view of the package, 100, of the present invention tilted during dispensing. A line, A-A, drawn perpendicular to the package bottom (not shown in FIG. 2) and in FIG. 2, line A-A is also perpendicular to the plane formed by the mouth, 118, forms a dispensing angle, α, with a vertical line, B-B, drawn perpendicular to the ground. When the package, 100, contains the pourable product, 144, and is tilted to a dispensing angle, α, of about 150°, the pourable product, 144, flows from the first internal volume, 116, through the flow-regulating passage, 132, into the second internal volume, 130, as indicated by arrow C. The pourable product, 144, then flows from the second internal volume, 130, through the dispensing passage, 134, and off of the pouring spout, 140, as indicated by arrow D, and into the cap, 146. The cap, 146, has a dosing device, 148, and a measuring indicator, 150, to advise the user how much of the pourable product, 144, to dose. Since the pourable product, 144, flows out of the second internal volume, 130, and therefore the pouring spout, 140, at a substantially constant rate, it is easy to accurately measure and dose the pourable product, 144. Furthermore, in the embodiment of FIG. 2, the flow-regulating passage, 132, extends from near the mouth, 118 to the base, 142, so that at a given dispensing angle of, for example, 150°, substantially all of the pourable product, 144, will flow out of the first internal volume, 116, through the flow-regulating passage, 132, into the second internal volume, 130, and out of the dispensing passage, 134. In FIG. 2, the base, 142, is flat and defines the imaginary line E-E. The mouth, 118, also defines the imaginary line F-F. A base angle, γ, is formed by the intersection of imaginary lines E-E and F-F. The base angle, γ can be between from about 0° to about 180°.

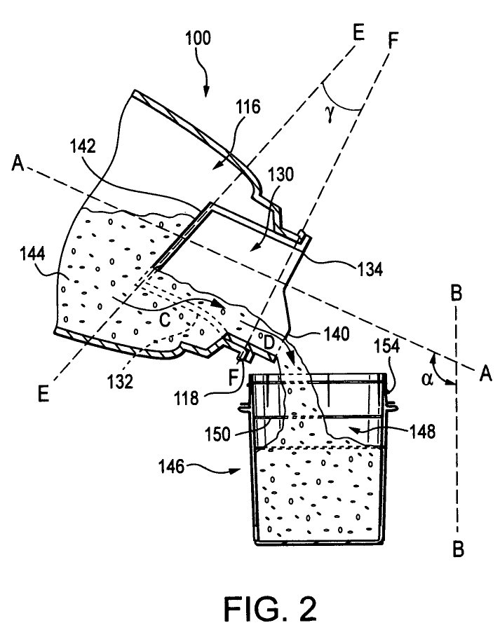

FIG. 3 shows a partial cut-away side view of a comparative package, 200, for dispensing a pourable product, 144, (shown in FIG. 2) with a pouring hole, 210, and an inclined plane, 212, to the interior of the pouring hole, 210. However, when the comparative package, 200, is tilted at various degrees from about 100° to about 150°, the pourable product, 144, (shown in FIG. 2) therein flows out of the pouring hole, 210, at dramatically different rates.

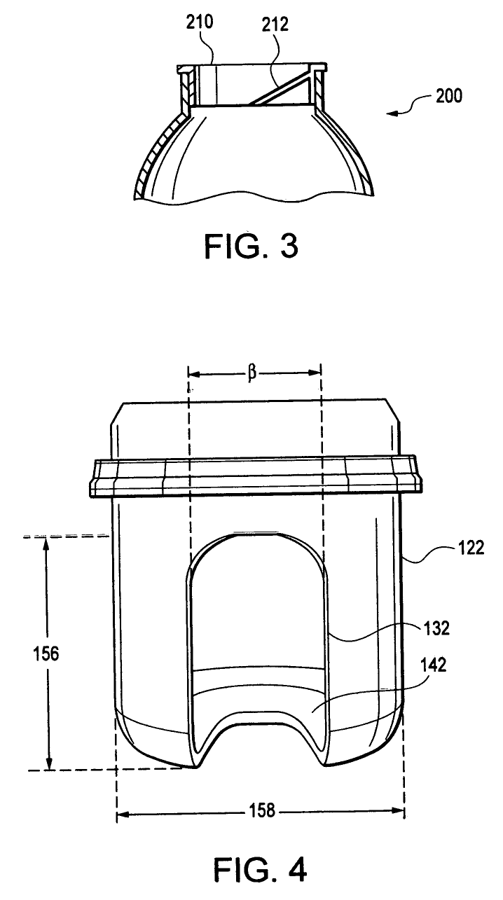

FIG. 4 shows a close-up side view of a second hollow body member, 122, and the flow-regulating passage, 132, therein. The flow-regulating passage, 132, extends from the base, 142, to almost to the edge, 138 (shown in FIG. 1). The flow-regulating passage, 132, has a width, 0, which is defined as the widest part of the flow-regulating passage, and is substantially wider than the average particle diameter of the pourable product, 144. In FIG. 4, the width extends from near the mouth, 118, (shown in FIG. 2) to the base, 142. In an embodiment herein, the width, β, is adjacent to the mouth, 118. In another embodiment herein, the width, β, of the flow-regulating passage, 132, is near the base, 142. In an embodiment herein, the width, β, of the flow-regulating passage, 132, is at least about 5 times wider than the average particle diameter, or from about 5 times to about 1,000 times wider than the average particle diameter, or from about 10 times to about 100 times wider than the average particle diameter. Without being limited by theory, it is believed that such a wide flow-regulating passage, 132, will enhance the free-flow properties of the pourable product, 144.

The width, 158, of the base, 142 can vary. In one non-limiting example, the width, 158, of the base, 142, can be from about 0 mm to about 127 mm. In yet another non-limiting example, the width, 158, of the base, 142, can be about 127 mm. The width, 158, of the base, 142, provides an increased surface area for the consumer to pour any unused product back into the package, specifically the first hollow body member, 110 (shown in FIG. 1).

The base, 142, can be any shape. Accordingly, the base, 142 can be of any suitable shape including, but not limited to, circular, oval, flattened circular, elliptical, and any combination thereof.

The package and/or any portion thereof may be formed of a variety materials such as a plastic or polymers, rubber, glass, metal, wood, or a combination thereof. An embodiment of the package and/or container includes rubber, plastic, polyester, and a combination thereof, and another embodiment includes polyethylene, polypropylene, polyethylene terephthalate, polypropylene terephthalate, polycarbonate, polystyrene, ethyl vinyl alcohol, thermoplastic elastomer, or a combination thereof. Flexible package and/or container parts preferably contain at least a portion of thermoplastic elastomer. Textured surfaces may also be employed so as to enhance gripping and/or friction, if desired.

Preferred production processes are blow molding, injection molding, vacuum forming, thermoforming, casting, stereo lithography, selective laser scintering, any rapid prototyping technology, and a combination thereof. The various individual package and/or portions thereof may be formed with different materials, and/or by different processes, as desired. Optional, but preferred characteristics of the package material include color, tinting, UV blocking agents, translucency, transparency, or opaqueness. Examples of the UV blocking agent useful herein include titanium dioxide, benzophenone, hydroxy-benzophenone, benzotriazole, and a mixture thereof. Such UV blocking agents are commonly available from, for example, Sumitomo Chemical, Tokyo Japan; Kyodo Chemical, Tokyo Japan; Asahi Denka, Tokyo Japan; Ciba Giegy, Tokyo Japan; and others. In one embodiment, the package can be colored. In another embodiment, the package could be transparent or translucent and optionally contains a UV blocking agent to absorb, reflect, or otherwise reduce the amount of UV light penetrating the container to reach the granular product so as to thereby reduce possible UV damage thereto, fading of the product color, especially if colored speckles are present, and/or yellowing of the granular product caused by exposure to UV radiation. Other optional characteristics of the package material include easy formation to the desired shape(s), resistance to the product and the applicable pH ranges, temperature, durability, coloration, coatings and/or resiliency. In an embodiment of the invention, the package material should be resistant to damage and deformation at temperatures from about −10° C. to about 90° C. The package may be sized to hold whatever volume is desirable. In an embodiment herein, the first internal volume, 116, is from about 0.5 mL to about 10 L, or from about 1 mL to about 5 L. In an embodiment herein for a granular detergent the first internal volume, 116, is from about 150 mL to about 3 L or from about 200 mL to about 1 L.

### C. FLOW RATE OF TEST METHOD

i. Product is a Granular

As used herein, the phrase “average rate” describes the rate at which the granular product flows from the dispensing passage when the dispensing angle is about 150°. To measure the average rate, the first internal volume, 116, is filled with a predetermined volume, typically at least 50%, preferably 90% of the granular product. The package is tilted to a dispensing angle of 150° for a period of 5 seconds, and the volume of beads which flow out of the dispensing passage during this time is collected and measured by weight, and the flow rate per second is calculated by dividing the weight by 5 seconds. In the case where the granular product stops flowing and/or is completely emptied from the package before the 5 second period is finished, then the weight is divided by amount of time required for the granular product to stop flowing/completely empty from the package. The flow rate is measured and calculated 5 times. From these 5 calculated flow rates the average flow rate, standard deviation, and standard deviation as a percentage of the flow rate are calculated.

As used herein, the term “substantially constant rate”, indicates that when the dispensing angle is measured at dispensing angles of 120° and 150°, the granular product continuously flows out of the package at the average rate where the standard deviation for each dispensing angle is less than about 20 grams of the average flow rate, or from about 0 grams to about 20 grams of the average flow rate. To determine whether or not the flow rate has these characteristics, the above flow rate test method is also conducted at a dispensing angle of 120° and a dispensing angle of 150°.

ii. Product is a Fluid

As used herein, the phrase “average rate” describes the rate at which the fluid product flows from the dispensing passage when the dispensing angle is about 150°. To measure the average rate, the first internal volume, 116, is filled with a predetermined volume, typically at least 50%, preferably 90% of the fluid product. The package is tilted to a dispensing angle of 150° for a period of 5 seconds, and the volume of beads which flow out of the dispensing passage during this time is collected and measured by weight, and the flow rate per second is calculated by dividing the weight by 5 seconds. In the case where the fluid product stops flowing and/or is completely emptied from the package before the 5 second period is finished, then the weight is divided by amount of time required for the fluid product to stop flowing/completely empty from the package. The flow rate is measured and calculated 5 times. From these 5 calculated flow rates the average flow rate, standard deviation, and standard deviation as a percentage of the flow rate are calculated.

As used herein, the term “substantially constant rate”, indicates that when the dispensing angle is measured at dispensing angles of 120° and 150°, the fluid product continuously flows out of the package at the average rate where the standard deviation for each dispensing angle is less than about 30 grams of the average flow rate, or from about 0 to about 30 grams of the average flow rate. To determine whether or not the flow rate has these characteristics, the above flow rate test method is also conducted at a dispensing angle of 120° and a dispensing angle of 150°.

### D. EXAMPLES

Examples of the invention are set forth hereinafter by way of illustration and are not intended to be in any way limiting of the invention. The examples are not to be construed as limitations of the present invention since many variations thereof are possible without departing from its spirit and scope.

### Example I

The package of FIGS. 1a and 2, including the cap, is formed from blow-molded polyethylene terephthalate, containing 0.01% by weight of a UV blocker. The first internal volume is about 1700 mL and the distinct and separately-formed second internal volume is about 115 mL. The mouth is round and has a diameter of 5 cm, and the second hollow body member has a threaded closure which forms a seal with the mouth. The flow-regulating passage has a width of 23 mm and the base angle is about 110. When tested at dispensing angles of about 120° and 150° according to the flow rate test method herein, the granular product flows out of the dispensing passage and therefore the pouring spout where the standard deviation for each dispensing angle is as follows:

The package is packed with a granular laundry detergent having an average particle diameter of about 400 μ. The pouring spout indicates the right direction of tipping for better product pouring with reduced spillage. The bottom of the base has a concave outside to guide product in the bottle to the flow-restriction passage to further improve product flow. The first hollow body member is formed from extrusion blow molded or injection blow molded polypropylene, while the cap is made from injection molded polypropylene. The second hollow body member is formed form injection molded polyethylene.

### Example II

The package of FIGS. 1a and 2, including the cap, is formed from blow-molded polyethylene terephthalate, containing 0.01% by weight of a UV blocker. The first internal volume is about 2600 mL and the distinct and separately-formed second internal volume is about 120 mL. The mouth is round and has a diameter of 7 cm, and the second hollow body member has a threaded closure which forms a seal with the mouth. The flow-regulating passage has a width of 15 mm and the base angle is about 11°. When tested at dispensing angles of about 120° and 150° according to the flow rate test method herein, the granular product flows out of the dispensing passage and therefore the pouring spout where the standard deviation for each dispensing angle is as follows:

The package is packed with a granular laundry detergent having an average particle diameter of about 400 μ. The pouring spout indicates the right direction of tipping for better product pouring with reduced spillage. The bottom of the base has a concave outside to guide product in bottle to the flow-restriction passage to further improve product flow. The first hollow body member is formed from extrusion blow molded or injection blow molded polypropylene, while the cap is made from injection molded polypropylene. The second hollow body member is formed form injection molded polyethylene.

### Example III

The package of FIGS. 1 and 2, including the cap, is formed from blow-molded polyethylene terephthalate, containing 0.01% by weight of a UV blocker. The first internal volume is about 3400 mL and the distinct and separately-formed second internal volume is about 125 mL. The mouth is round and has a diameter of 9 cm, and the second hollow body member has a threaded closure which forms a seal with the mouth. The flow-regulating passage has a width of 30 mm and the base angle is about 11°. When tested at dispensing angles of about 120° and 150° according to the flow rate test method herein, the granular product flows out of the dispensing passage and therefore the pouring spout where the standard deviation for each dispensing angle is as follows:

The package is packed with a granular laundry detergent having an average particle diameter of about 400 μ. The pouring spout indicates the right direction of tipping for better product pouring with reduced spillage. The bottom of the base has a concave outside to guide product in bottle to the flow-restriction passage to further improve product flow. The first hollow body member is formed from extrusion blow molded or injection blow molded polypropylene, while the cap is made from injection molded polypropylene. The second hollow body member is formed form injection molded polyethylene.

### Example IV

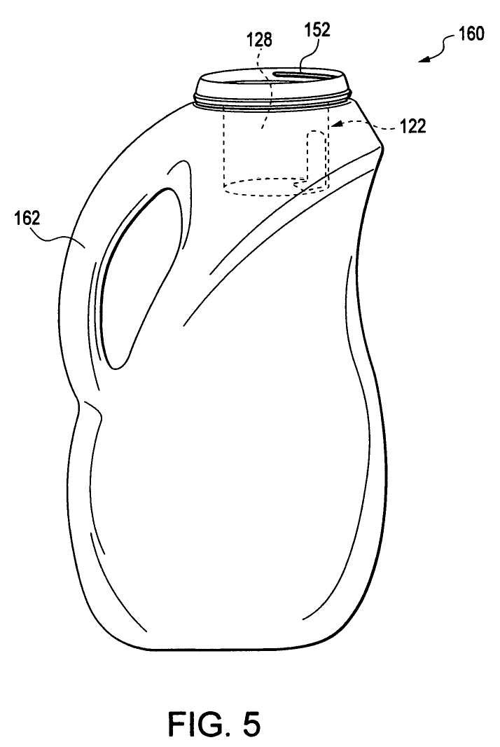

Referring FIG. 5, an alternative embodiment of a package, 160, having a handle 162 is shown. The package 160 has a second hollow body member, 122 with a second interior surface, 128. Fasteners, 152, (e.g. threads), are disposed on the second interior surface, 128.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A package for dispensing a pourable product, the package comprising:
A. a first hollow body member having:
i. a first exterior surface; and
ii. a first interior surface opposite the first exterior surface, the first interior surface defining a first internal volume;
B. a second hollow body member, wherein the second hollow body member has:
i. a second exterior surface defining a second external volume smaller than the first internal volume;
ii. a second interior surface opposite the second exterior surface, the second interior surface defining a second internal volume, wherein a fastener is formed on said second interior surface;
iii. a flow-regulating passage leading from the second exterior surface to the second interior surface; and
iv. a dispensing passage leading from the second interior surface to the second exterior surface, wherein the dispensing passage is separate from the flow-regulating passage,
wherein at least a portion of the second hollow body member is within the first internal volume.

2. The package according to claim 1, wherein when the first internal volume is at least about 50% full of the pourable product therein the package may be tilted for dispensing, whereby when tilted for dispensing at a dispensing angle the pourable product flows from the first internal volume through the flow-regulating passage into the second internal volume and from the second internal volume through the dispensing passage out of the package, and wherein when the flow rate is measured and calculated at a dispensing angle of 120°, the standard deviation is less than about 20 grams of the average flow rate; at a dispensing angle of 150°, the standard deviation is less than about 20 grams of the average flow rate.

3. The package according to claim 1, wherein said fastener is selected from the group consisting of lugs, grooves, threads, or plug seals.

4. The package according to claim 1, wherein the first hollow body member further comprises a mouth, and wherein the second exterior surface is affixed to the mouth.

5. The package according to claim 1, wherein the first hollow body member further comprises a mouth, and wherein the flow-regulating passage further comprises an edge, and wherein the edge is located at the portion of the second exterior surface which is affixed to the mouth.

6. The package according to claim 1, wherein the second hollow body member comprises a pouring spout.

7. The package according to claim 1, wherein at least a portion of the flow-regulating passage is distal from the dispensing passage.

8. The package according to claim 1, wherein the pourable product has an average particle diameter, and wherein the flow-regulating passage has a width, and wherein the width is at least about 5 times wider than the average particle diameter.

9. The package according to claim 1, wherein the first hollow body member and the second hollow body member are distinct.

10. The package according to claim 1, wherein the second hollow body member further comprises a base opposite the dispensing passage, and wherein the flow-regulating passage extends to the base.

11. The package according to claim 10, wherein a first imaginary line is formed by said base, said first hollow body member further comprises a mouth and a second imaginary line is formed by said mouth, wherein said first imaginary line and said second imaginary line span a radial arc identified as γ.

12. The package according to claim 11, wherein said angle, γ, can be between from about 0° to about 180°.

13. The package according to claim 1, wherein the second internal volume is from about 1% to about 25% of the first internal volume.

14. The package according to claim 1, further comprising a cap which removably covers the dispensing passage.

15. The package according to claim 9, wherein the first hollow body member and the second hollow body member are affixed to each other.

16. The package according to claim 1, wherein said pourable product is a granular product therein.

17. The package according to claim 1, wherein said pourable product is a fluid product therein.

18. The package according to claim 16, wherein the granular product is a granular detergent.

19. A package for dispensing a granular product, the package comprising:
A. a first hollow body member having:
i. a first exterior surface; and
ii. a first interior surface opposite the first exterior surface, the first interior surface defining a first internal volume;
B. a cap having:
i. a cap exterior surface;
ii. and a cap interior surface opposite said cap exterior surface,
wherein a cap fastener is formed on said cap exterior surface;
C. a second hollow body member, wherein the second hollow body member has:
i. a second exterior surface defining a second external volume smaller than the first internal volume;
ii. a second interior surface opposite the second exterior surface, the second interior surface defining a second internal volume, wherein a fastener is formed on said second interior surface for receiving said cap fastener;
iii. a flow-regulating passage leading from the second exterior surface to the second interior surface; and
iv. a dispensing passage leading from the second interior surface to the second exterior surface, wherein the dispensing passage is separate from the flow-regulating passage,
wherein at least a portion of the second hollow body member is within the first internal volume.

20. The package according to claim 18, wherein said fastener is a thread and
wherein said cap fastener is a thread.
